(19) United States
(12) Patent Application Publication
(10) Pub. No.: US 2025/0239385 A1
(43) Pub. Date: Jul. 24, 2025

(54) WEAR DETECTABLE CABLE, WEAR DETECTION DEVICE, AND WEAR DETECTION METHOD

(71) Applicant: Proterial, Ltd., Tokyo (JP)

(72) Inventors: Katsutoshi NAKATANI, Tokyo (JP); Izumi FUKASAKU, Tokyo (JP); Takahiro SUGIYAMA, Tokyo (JP); Noriyuki IMAI, Tokyo (JP); Masashi MORIYAMA, Tokyo (JP); Ayano KATO, Tokyo (JP)

(21) Appl. No.: 19/027,807

(22) Filed: Jan. 17, 2025

(30) Foreign Application Priority Data
Jan. 18, 2024 (JP) 2024-006231

(51) Int. Cl. H01B 7/32; G01N 21/952; H01B 7/18

(52) U.S. Cl. CPC H01B 7/32; G01N 21/952; H01B 7/1875

(57) ABSTRACT

A wear detectable cable includes a conductor section comprising a linear conductor, and a sheath covering the conductor section, and wear of the sheath can be detected by reflection of light irradiated toward the sheath. The sheath includes a first region having a first reflective property for the light and a second region having a second reflective property different from the first reflective property for the light, and the second region is formed continuously with the first region inside the first region. A wear detection device for detecting wear of the sheath of the wear detectable cable includes an irradiation unit for irradiating the light toward the sheath, a light receiving unit for receiving reflected light of the light, and a detection processing unit that detects that the first region is worn away and the second region is exposed, based on a measurement result of an intensity of the reflected light received by the light receiving unit.

### CROSS-REFERENCE TO RELATED APPLICATIONS

The present patent application claims the priority of Japanese patent application No. 2024-006231 filed on Jan. 18, 2024, the entire contents of which are incorporated herein by reference.

### TECHNICAL FIELD

The present invention relates to a wear detectable cable (i.e., cable suitable for wear detection), which comprises a conductor section including a linear conductor and a sheath, for easy detection of sheath wear, a wear detection device for detecting sheath wear, and a sheath wear detection method.

### BACKGROUND OF THE INVENTION

Conventionally, cables composed of multiple wires covered by a sheath may be installed in wear (i.e., abrasion)-prone areas in machinery and equipment. The Applicant has proposed the cable described in Patent Literature 1 as a cable used for supplying electric power to a moving object (i.e., a mobile body) in a non-contact manner. In this cable, the magnetic field generated by the current flowing in the wires generates an induced voltage in the coil installed in the moving object, and the cable supplies the moving object with electric power for it to move. Also described in Patent Literature 1 is an enclosure having a pair of side walls and a bottom wall, in which the cable is housed between the pair of side walls in the enclosure.

### CITATION LIST

Patent Literature 1: JP2021-047991A

### SUMMARY OF THE INVENTION

In the cable described in Patent Literature 1, if a part of the cable protrudes from the housing due to cable undulation, for example, the sheath of the protruding part may come into contact with the coil and other components in the moving object, causing wear. If such sheath wear occurs, it is desirable to detect it at an early stage and take measures such as replacing or repairing the cable. However, it is not easy to detect sheath wear at an early stage because cables are sometimes installed in locations that are difficult for workers and others to visually check.

It is, therefore, an object of the present invention to provide a wear detectable cable, a wear detection device for detecting sheath wear, and a wear detection method for a sheath, which are easy to detect that wear has occurred on a sheath.

To solve the problems described above, one aspect of the invention provides a wear detectable cable, comprising: a conductor section comprising a linear conductor; and a sheath covering the conductor section, wherein wear of the sheath can be detected by reflection of light irradiated toward the sheath, wherein the sheath comprises a first region having a first reflective property for the light and a second region having a second reflective property different from the first reflective property for the light, and wherein the second region is formed continuously with the first region inside the first region.

To solve the problems described above, another aspect of the invention provides a wear detection device for detecting wear of the sheath of the wear detectable cable, according to the above aspect, comprising an irradiation unit for irradiating the light toward the sheath; a light receiving unit for receiving reflected light of the light; and a detection processing unit that detects that the first region is worn away and the second region is exposed, based on a measurement result of an intensity of the reflected light received by the light receiving unit.

To solve the problems described above, still another aspect of the invention provides a wear detection method for detecting wear of a sheath in a cable comprising a conductor section including a linear conductor, and the sheath covering the conductor section, the method comprising measuring reflected light of light irradiated toward the sheath, the sheath comprising a first region having a first reflective property for the light and a second region having a second reflective property different from the first reflective property for the light, the second region being formed continuously with the first region inside the first region; and detecting that the first region is worn away and the second region is exposed, based on a measurement result of the reflected light.

To solve the problems described above, a further aspect of the invention provides a wear detection method for detecting wear of a sheath in a cable comprising a conductor section including an insulated wire comprising a linear conductor covered with an insulator, and the sheath covering the conductor section, the method comprising measuring reflected light of light irradiated toward the sheath, the sheath comprising a first region having a first reflective property for the light and a second region having a second reflective property different from the first reflective property for the light, the second region being formed continuously with the first region inside the first region, the insulator of the insulated wire having a third reflective property, for the light, different from the first reflective property and the second reflective property; and detecting that the first region and the second region are worn away and the insulator of the insulated wire is exposed, based on a measurement result of the reflected light.

### Effects of the Invention

According to the wear detectable cable of the present invention, it is easier to detect that wear has occurred on the sheath. According to the wear detection device and wear detection method of the present invention, it is possible to detect that wear has occurred on the sheath by the reflection of light irradiated toward the sheath.

### BRIEF DESCRIPTION OF DRAWINGS

FIG. 1 is a schematic diagram showing an example configuration of a mobile (moving object) system in which a cable is used as a guide line.

FIG. 2 is a configuration diagram showing the mobile system viewed from the horizontal direction.

FIG. 3 is a configuration diagram showing cross-sections of the right and left portions and peripheral portions of the cable, together with the schematic configuration of a power supply unit of a transport cart.

FIG. 4 is a cross-sectional view of an example configuration of a cable.

FIG. 5A is an explanatory diagram showing an example configuration of the wear detection device together with the cables where wear has occurred at the first and second locations.

FIG. 5B is an explanatory diagram showing the first and second locations viewed from the wear detection device side.

### DETAILED DESCRIPTION OF THE INVENTION

### Embodiment

The following is an example of the application of a wear detectable cable in the present embodiment of the present invention to a mobile (i.e., moving object) system, which will be described based on the drawings. This wear detectable cable can be suitably used in applications where it is laid in places where wear is likely to occur and where the occurrence of wear should be detected at an early stage when it occurs, and in particular, it has an excellent effect when used in machinery and equipment in combination with the wear detection device to be described below.

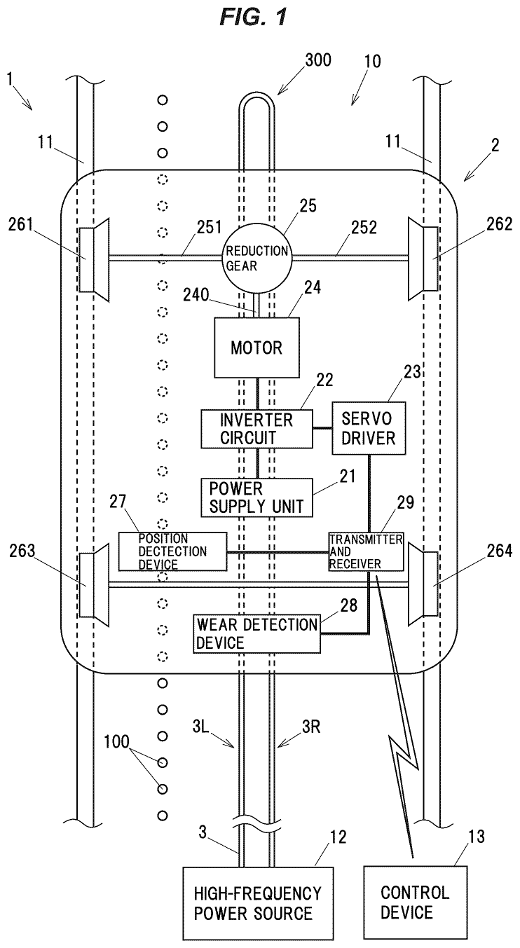

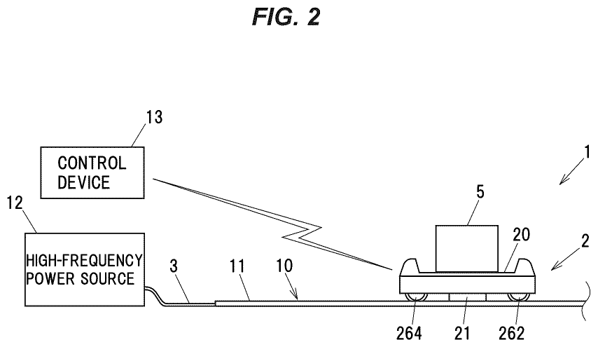

FIG. 1 is a schematic diagram of a mobile system 1 in which the cable 3 is used as a guide line. FIG. 2 is a configuration diagram of the mobile system 1 viewed from the horizontal direction.

In the present embodiment, the mobile system 1 is configured as a tracked unmanned transport system, in which a moving object, a transport cart 2, moves along a pair of rails 11 laid on a traveling path 10, loading a transport object 5 (shown in FIG. 2) on a cargo bed 20. The traveling path 10 is provided with a plurality of markers 100 for detecting the position of the transport cart 2. The mobile system 1 includes the transport cart 2, a cable 3, a high-frequency power source 12 that applies a high-frequency AC current to the cable 3, and a control device 13 that controls the transport cart 2. The control device 13 transmits and receives various signals to and from the transport cart 2 through wireless communication.

The transport cart 2 includes a power supply unit 21 that generates DC voltage by the energy of the magnetic field generated by the AC current flowing in the cable 3, an inverter circuit 22 with multiple switching elements that switch the DC voltage supplied from the power supply unit 21, a servo driver 23 that outputs on/off signals to the multiple switching elements of the inverter circuit 22, a motor 24 to which a drive current is supplied from the inverter circuit 22, and a reduction gear 25 that reduces the rotation of an output rotation shaft 240 of the motor 24 to rotate left and right rotation shafts 251, 252, and drive wheels 261, 262 connected to the left and right rotation shafts 251, 252 respectively, driven wheels 263, 264, which are rotated by the advancing and retreating movement (forward/backward movement) of the transport cart 2 by the drive wheels 261, 262, a position detection device 27, which detects the position of the transport cart 2 by the positions of the multiple markers 100, a wear detection device 28, which detects wear of the cable 3, and a transmitter and receiver (transmitter/receiver) 29, which communicates with the control device 13.

The servo driver 23, the position detection device 27, and the wear detection device 28 are connected to the transmitter/receiver 29, which enables two-way communication with the control device 13. The servo driver 23 controls the inverter circuit 22 with PWM based on command signals from the control device 13. The position detection device 27 sends a signal indicating the detected position of the transport cart 2 to the control device 13. The wear detection device 28 sends a signal indicating the degree of wear of the cable 3 to the control device 13. The control device 13 can stop the transport cart 2 at any position within a travel range of the transport cart 2 by sending a command signal to the servo driver 23 based on the signal indicating the position of the transport cart 2 sent from the position detection device 27.

The cable 3 extends along the rails 11 with both ends connected to high-frequency power source 12 and is folded back at a turnaround portion 300. The cable 3 extends over a longer range than the travel range of the transport cart 2. Hereafter, the direction in which the transport cart 2 approaches the turnaround portion 300 is referred to as the forward direction of the transport cart 2, and vice versa is referred to as the backward direction. A right side portion 3R of the cable 3 folded at the turnaround portion 300 with respect to the forward direction is referred to as the right side portion 3R, and a left side portion 3L of the cable 3 folded at the turnaround portion 300 with respect to the forward direction is referred to as the left side portion 3L. The right side portion 3R and the left side portion 3L of the cable 3 extend parallel to each other along the forward and backward directions of the transport cart 2.

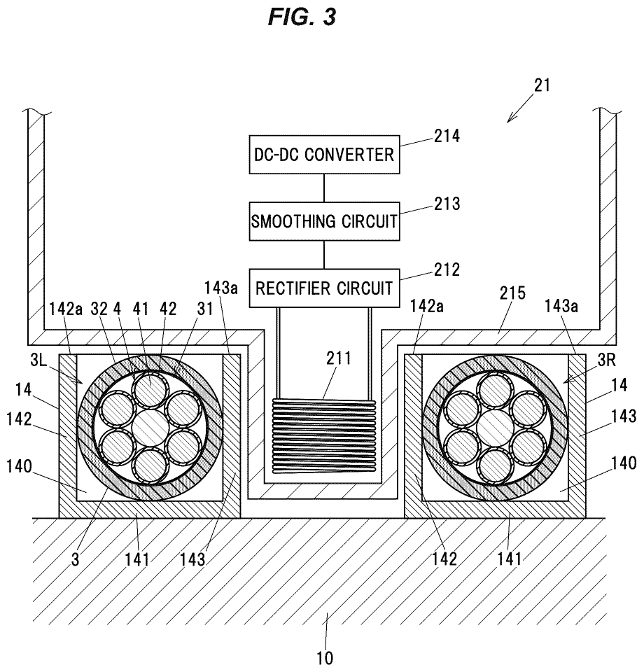

FIG. 3 is a configuration diagram showing cross-sections of the right side portion 3R and left side portion 3L and peripheral portions of the cable 3, along with a schematic configuration of the power supply unit 21. The cable 3 is held by cable guides 14 located on the traveling path 10. The cable guides 14 are arranged corresponding to the right side portion 3R and the left side portion 3L of the cable 3, respectively. Each cable guide 14 has a bottom wall 141 facing the traveling path 10 and a pair of side walls 142, 143 standing upwardly from the bottom wall 141, and the cable 3 is contained in a accommodation space 140 between the pair of side walls 142, 143. The accommodation space 140 is open vertically upward toward the transport cart 2. The depth of the accommodation space 140 from tip surfaces 142a, 143a of the pair of side walls 142, 143 is substantially equal to an outer diameter of the cable 3.

The power supply unit 21 includes a pickup coil 211, a rectifier circuit 212, a smoothing circuit 213, a DC-DC converter 214, and a case member 215 that houses them. An AC voltage is generated in the pickup coil 211 when the magnetic flux of the magnetic field generated by the AC current flowing in the cable 3 is chained together. The rectifier circuit 212 converts the AC voltage of the pickup coil 211 to a DC voltage, for example, by means of a diode bridge circuit. The smoothing circuit 213 smoothes the DC voltage converted by the rectifier circuit 212. The DC-DC converter 214 converts the output voltage of the smoothing circuit 213 into a supply voltage to the inverter circuit 22.

The pickup coil 211 is positioned between the cable guide 14, which accommodates the right side portion 3R of the cable 3, and the cable guide 14, which accommodates the left side portion 3L of the cable 3, with being housed in the case member 215. In the pickup coil 211, the direction in which the magnetic flux generated by the current flowing in the right side portion 3R of the cable 3 is chained and the direction in which the magnetic flux generated by the current flowing in the left side portion 3L of the cable 3 is chained are the same. The right side portion 3R and the left side portion 3L of the cable 3 face the case member 215 in the vertical direction, respectively. A plurality of pickup coils 211 may be arranged side by side along the extension direction of the cable 3.

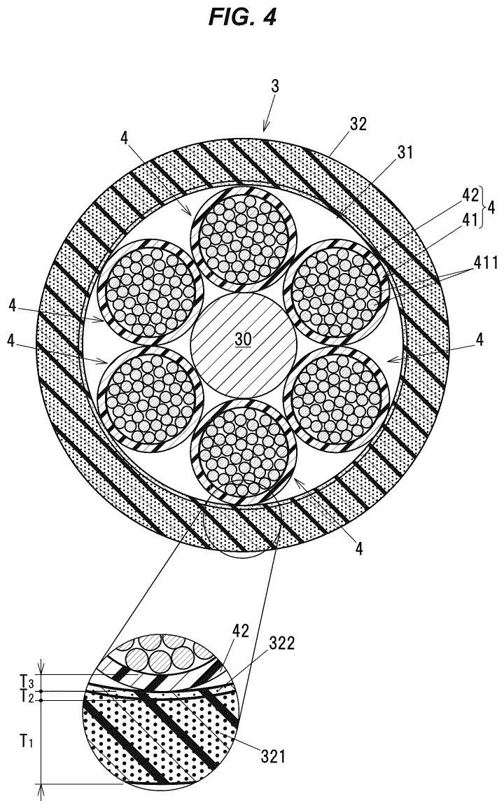

FIG. 4 is a cross-sectional view of an example configuration of the cable 3. The cable 3 has a conductor section 31 and a sheath 32 as a jacket covering the conductor section 31. In the present embodiment, the conductor section 31 has a plurality of insulated wires 4. A center filler 30 made of an insulator is arranged in the center of the cable 3, and six insulated wires 4 are arranged around the center filler 30. The six insulated wires 4 are twisted together in a spiral shape around the center filler 30 and are connected in parallel to the high-frequency power source 12. Each insulated wire 4 has a linear conductor 41 covered by an insulator 42. The conductor 41 comprises a plurality of conductor strands 411 made of a good conductive metal such as copper. The insulator 42 is made of, for example, fluoro resins such as ETFE (tetrafluoroethylene-ethylene copolymer), FEP (tetrafluoroethylene-hexafluoropropylene copolymer), PTFE (polytetrafluoroethylene), PVDF (prefluorinated vinylidene), polyimide, and PEEK (polyetheretherketone) can be suitably used. The outer diameters of multiple insulated wires 4 are common. The conductor cross-sectional area of conductor 41 in each insulated wire 4 is, for example, 7 mm² or more.

In place of the center filler 30, a heat detection wire that can detect when the insulated wire 4 becomes overheated due to Joule heat may be arranged. As this heat detection wire, for example, a plurality of heat detection-adapted electric wires whose conductors are covered with an insulator having a melting point lower than that of the insulator 42 of the insulated wire 4 can be twisted together. In this case, it is possible to detect that the insulated wire 4 has become hot when the insulators of the plurality of heat detection-adapted electric wires melt and the conductors short-circuit each other. The heat detection wires and the heat detection-adapted electric wires may be located outside the center of the cable 3, such as between adjacent insulated wires 4.

The cable 3 can detect wear (scraping, shaving) of the sheath 32 by the reflection of light emitted toward the sheath 32. In FIG. 4, a portion of the sheath 32 is shown enlarged in the blowout area. The sheath 32 has a first region 321 having a first reflective property for irradiated light and a second region 322 having a second reflective property different from the first reflective property for this light, and the second region 322 is formed inside the first region 321 continuously with the first region 321.

The first region 321 and the second region 322 are made of the same type of resin material. This enhances the adhesion between the first region 321 and the second region 322. For example, PVC (poly vinyl chloride) can be suitably used as the resin material for the first region 321 and the second region 322. In manufacturing the cable 3, the molten resin that will become the first region 321 is extruded around the conductor section 31, and the molten resin that will become the second region 322 is extruded before this molten resin has hardened. This allows the second region 322 to be continuously formed around the periphery of the first region 321 without gaps.

A thickness T₂ of the second region 322 in the radial direction of the cable 3 is thinner than a thickness T₁ of the first region 321. The thickness T₂ of the second region 322 being thinner than the thickness T₁ of the first region 321 prevents wear of the sheath 32 from being detected with excessively high sensitivity. The thickness T₂ of the second region 322 is, for example, about 10% (between 5% and 15%) of the thickness T₁ of the first region 321. The overall thickness of the sheath 32, including the thickness T₁ of the first region 321 and the thickness T₂ of the second region 322, is, for example, 0.6 mm or more and 1.0 mm or less. A thickness T₃ of the insulator 42 should be thicker than the thickness T₂ of the second region 322. The thickness T₃ of the insulator 42 being thicker than the thickness T₂ of the second region 322 makes it easier to detect wear in the second region 322 by exposure of the insulator 42 before the conductor 41 is exposed.

In the present embodiment, as an example, the first region 321 is more absorbent of light than the second region 322. In other words, the reflectance of light in the second region 322 is higher than the reflectance of light in the first region 321. More specifically, the lightness of the color of the second region 322 is higher than the lightness of the color of the first region 321. The first region 321 is, for example, black, and the second region 322 is, for example, gray or white. However, the colors of the first and second regions 321 and 322 are not limited to achromatic colors, but may also be colorful colors. For example, if the second region 322 is a color easily visible to the naked eye, such as orange or yellow, it will be easier for a worker or other person to visually identify the worn areas of the sheath 32.

In the present embodiment, the insulators 42 of each of the plurality of insulated wires 4 have a third reflective property that is different from the first reflective property of the first region 321. In the present embodiment, the third reflective property is also different from the second reflective property. However, the third reflective property may be the same as the first or second reflective property. When the insulator 42 has the third reflective property that is different from both the first reflective property and the second reflective property of the second region 322, the color of the respective insulators 42 of the insulated wire 4 is a color of higher lightness (such as light gray or white) than the color of the second region 322 of the sheath 32, for example. However, the light reflectance of the insulator 42 of the insulated wires 4 may be a value between the light reflectance of the first region 321 and the light reflectance of the second regions 322 of the sheath 32. The light reflectance of the insulator 42 of the insulated wire 4 may be lower than the light reflectance of the first region 321 and the light reflectance of the second regions 322 of the sheath 32. This allows the cable 3 to detect wear (scraping, shaving) of the sheath 32 by exposure of the insulator 42.

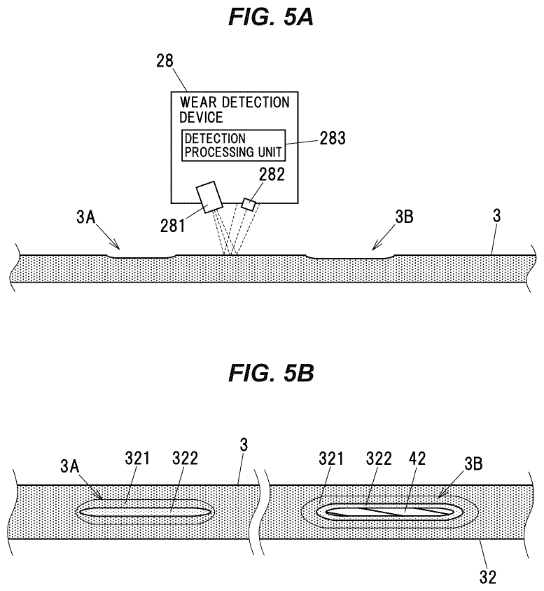

If a part of the cable 3 protrudes upward from the cable guide 14 due to the undulation of the cable 3 itself, for example, the sheath 32 of the cable 3 may be worn away by contact with the components of the transport cart 2 such as the case member 215 when the transport cart 2 runs. If the wear of the sheath 32 progresses without being detected, the insulator 42 of the insulated wire 4 may wear out following the sheath 32, exposing the conductor 41 of the insulated wire 4. Next, the configuration of the wear detection device 28 of the transport cart 2 for detecting the cable 3 as a detection target and the method of detecting the wear of the sheath 32 by the wear detection device 28 will be explained with reference to FIGS. 5A and 5B.

FIG. 5A is an explanatory diagram showing an example configuration of the wear detection device 28, together with the cable 3 with wear occurring at a first location 3A and a second location 3B. FIG. 5B is an explanatory diagram showing the first location 3A and the second location 3B as seen from the wear detection device 28 side. At the first location 3A, the first region 321 of the sheath 32 is worn away and the second region 322 is exposed. At the second location 3B, the first and second regions 321 and 322 of the sheath 32 are worn away, thereby exposing the insulation 42 of the insulated wire 4.

The wear detection device 28 includes an irradiation unit 281 that irradiates light toward the sheath 32 of the cable 3, a light receiving unit 282 that receives the reflected light from the sheath 32 as a result of the light irradiated by the irradiation unit 281, and a detection processing unit 283 that detects the degree of wear of the sheath 32 based on the measured intensity of the reflected light received by the light receiving unit 282. The function of the detection processing unit 283 may be provided on the control device 13 side. In this case, a signal indicating the measurement result of the intensity of the reflected light received by the light receiving unit 282 is transmitted from the transport cart 2 to the control device 13.

Since the cable 3 has the first reflective property in the first region 321 of the sheath 32, the second reflective property in the second region 322, and third reflective property in the insulator 42 of the insulated wire 4, which are different from each other, even if the intensity of the light irradiated toward the cable 3 by the irradiation unit 281 is constant, the intensity of the reflected light received by the light receiving unit 282 varies depending on the degree of wear. The wear detection method in the present embodiment uses this phenomenon to detect the degree of wear based on the measurement results of the reflected light of the light irradiated by the irradiation unit 281. In other words, the wear detection method in the present embodiment includes a step of irradiating light toward the cable 3, a step of measuring the reflected light reflected by the irradiated light on the cable 3, and a step of detecting the degree of wear based on the measurement result of this reflected light.

In the present embodiment, the irradiation unit 281 is an infrared LED (light emitting diode) and the light receiving unit 282 is an infrared light receiving element. However, the invention is not limited thereto. The irradiation unit 281 may be, for example, an LED that emits ultraviolet or white light, or an LD (laser diode) that emits laser light. The light receiving unit 282 may be capable of measuring light intensity at the wavelength of the light emitted by the irradiation unit 281. A photoreflector having the irradiation unit 281 and the light receiving unit 282 in one piece may also be used.

If the light emitted by the irradiation unit 281 is invisible light, such as infrared light, the color of the first region 321 and the second region 322 of the sheath 32 may be the same when viewed with the naked eye. Even in this case, the first and second reflective properties can be different from each other, for example, by using an infrared absorber in the first region 321 or an infrared reflector in the second region 322. Similarly, the color of the insulator 42 of the insulated wire 4 may be the same as the color of the first region 321 or the second region 322 of the sheath 32 when viewed with the naked eye.

The detection processing unit 283 has an AD converter and an arithmetic element or comparator, and detects the degree of wear of the sheath 32 according to whether the intensity of the reflected light detected by the light receiving unit 282 is higher or lower than a reference value. Specifically, based on the measurement results of the reflected light, it detects that the first region 321 of the sheath 32 is worn away and the second region 322 is exposed, and that the first region 321 and the second region 322 are worn away and the insulator 42 of the insulated wire 4 is exposed.

Furthermore, the detection processing unit 283 may detect that the conductor 41 has been exposed due to wear of the insulator 42 of the insulated wire 4 based on the measurement results of reflected light. Since the surface of conductor strand 411, which constitutes the conductor 41, has a higher light reflectance than the sheath 32 and the insulator 42, it is possible to detect that the conductor 41 has been exposed.

The detection processing unit 283 moves in the longitudinal direction of the cable 3 with respect to the cable 3 together with the transport cart 2 when the transport cart 2 moves in the forward and backward directions, so that the degree of wear of the sheath 32 can be detected over a length corresponding to the distance from the forward end to the backward end of the transport cart 2. The wear detection device 28 has the irradiation unit 281 and the light receiving unit 282 corresponding to the right side portion 3R and the left side portion 3L of the cable 3, respectively, and the wear degrees of the right side portion 3R and the left side portion 3L are detected simultaneously.

When the wear detection device 28 detects that the second region 322 of the sheath 32 is exposed and that the insulator 42 of the insulated wire 4 is exposed, the detection results are immediately transmitted to the control device 13. When the detection processing unit 283 detects that the insulator 42 of the insulated wire 4 is worn away and the conductor 41 is exposed, the detection result is also immediately transmitted to the control device 13.

The control device 13 reports the detection results of the wear detection device 28 in a manner according to the degree of wear. This reporting mode includes, for example, displaying an alarm message on a display device connected to the control device 13, or sending an e-mail to the manager or operator of a factory or other facility where the transport cart 2 is installed.

Since the control device 13 receives the detection result of the position of the transport cart 2 from the position detection device 27, it is possible to identify the position where the wear detection device 28 detected wear, i.e., the position where wear of the cable 3 is occurring, based on the detection result of the position of the transport cart 2 at the time when the wear detection device 28 received the wear detection result from the wear detection device 28. The control device 13 reports this position information together with the detection result of the wear detection device 28. This allows the operator to easily find the location where wear occurs on the cable 3 and to promptly take measures such as repair.

Even if wear is detected by the wear detection device 28, the function of the cable 3 itself is not affected, and the mobile system 1 can continue to operate. In other words, even if wear of the sheath 32 is detected by the wear detection device 28, there is a time margin before further wear progresses to expose the conductor 41 of the insulated wire 4, during which time a replacement cable 3 can be obtained or the cable 3 in use can be repaired.

### Functions and Effects of the Embodiment

According to the embodiment described above, since the first reflective property in the first region 321 and the second reflective property in the second region 322 of the sheath 32 are different from each other, it is possible to detect that wear has occurred on the sheath 32 by reflection of light irradiated toward the sheath 32. In addition, since the insulator 42 of the insulated wire 4 has the third reflective property that differs from the first and second reflective properties, it is also possible to detect that wear has progressed on the sheath 32 and the insulator 42 has been exposed. Furthermore, in the present embodiment, the irradiation unit 281 and the light receiving unit 282 of the wear detection device 28 move with respect to the cable 3 as the transport cart 2 moves, so that even without a dedicated mechanism for moving the irradiation unit 281 and the light receiving unit 282 with respect to the cable 3, the degree of wear of the cable 3 can be detected over a length corresponding to the distance from the forward end to the backward end of the transport cart 2.

### Modified Examples of the Embodiment

The present invention may be implemented by means of the following modified examples of the above embodiment. The first modified example of the embodiment is to make the hardness of the second region 322 of the sheath 32 harder than that of the first region 321. For example, when PVC is used as the resin material for the first region 321 and the second region 322 as described above, the second region 322 can be made harder than the first region 321 by adjusting the amount of plasticizer. By making the second region 322 harder than the first region 321, when wear of the sheath 32 progresses to the second region 322, further wear of the sheath 32 in the second region 322 and tearing of the sheath 32 to expose the insulated wire 4 can be suppressed.

The second modified example of the embodiment is to disperse light-reflective particles in the second region 322 to make the second reflective property of the second region 322 different from the first reflective property of the first region 321. The light-reflective particles can be, for example, titanium dioxide, aluminum oxide, silicon dioxide, or zirconium dioxide. With this second modified example of the embodiment, as in the above embodiment, it is possible to detect that wear has occurred on the sheath 32 by reflection of light irradiated toward the sheath 32.

The third modified example of the embodiment is to configure the surface roughness of the surface of the first region 321 and the surface (an interface with the first region 321) of the second region 322 to be different, so that the first reflective property of the first region 321 and the second reflective property of the second region 322 are different. This third modified example of the embodiment also allows detection of the occurrence of wear on the sheath 32 by reflection of light irradiated toward the sheath 32, as in the above embodiment.

### Summary of Embodiment

Next, the technical concepts that can be grasped from the above-described embodiment will be described with the aid of the codes, etc. in the embodiment. However, each code in the following description does not limit the components in the scope of claims to the parts, etc. specifically shown in the embodiment.

According to the first feature, a wear detectable cable 3 includes a conductor section 31 including a linear conductor 41, and a sheath 32 covering the conductor section 31, wherein wear of the sheath 32 can be detected by reflection of light irradiated toward the sheath 32, wherein the sheath 32 having a first region 321 having a first reflective property for the light and a second region 322 having a second reflective property different from the first reflective property for the light, and wherein the second region 322 is formed continuously with the first region 321 inside the first region 321.

According to the second feature, in the wear detectable cable 3 as described in the first feature, a thickness T₂ of the second region 322 is thinner than a thickness T₁ of the first region 321.

According to the third feature, in the wear detectable cable 3 as described in the first feature, the first region 321 and the second region 322 are composed of the same type of resin material.

According to the fourth feature, in the wear detectable cable 3 as described in the first feature, the conductor section 31 has an insulated wire 4 including the conductor 41 covered by an insulator 42, wherein the insulator 42 of the insulated wire 4 has a third reflective property, for the light, different from the first reflective property.

According to the fifth feature, in the wear detectable cable 3 as described in the fourth feature, the third reflective property is different from the second reflective property.

According to the sixth feature, in the wear detectable cable 3 as described in the fourth feature, a thickness T₃ of the insulator 42 is thicker than the thickness T₂ of the second region 322.

According to the seventh feature, in the wear detectable cable 3 as described in the first feature, a hardness of the second region 322 is harder than a hardness of the first region 321.

According to the eighth feature, in the wear detectable cable 3 as described in the first feature, the second region 322 is dispersed with light-reflective particles.

According to the ninth feature, a wear detection device 28 for detecting wear of the sheath 32 of the wear detectable cable 3 as described in any one of the first to eighth features includes an irradiation unit 281 for irradiating the light toward the sheath 32, a light receiving unit 282 for receiving reflected light of the light, and a detection processing unit 283 that detects that the first region 321 is worn away and the second region 322 is exposed, based on a measurement result of an intensity of the reflected light received by the light receiving unit 282.

According to the tenth feature, a wear detection method for detecting wear of a sheath 32 in a cable 3 having a conductor section 31 including a linear conductor 41 and the sheath 32 covering the conductor section 31, including measuring reflected light of light irradiated toward the sheath 32, the sheath 32 having a first region 321 having a first reflective property for the light and a second region 322 having a second reflective property different from the first reflective property for the light, the second region 322 being formed continuously with the first region 321 inside the first region 321, and detecting that the first region 321 is worn away and the second region 322 is exposed, based on a measurement result of the reflected light.

According to the eleventh feature, a wear detection method for detecting wear of a sheath 32 in a cable 3 having a conductor section 31 including an insulated wire 4 including a linear conductor 41 covered with an insulator 42 and the sheath 32 covering the conductor section 31, including measuring reflected light of light irradiated toward the sheath 32, the sheath 32 having a first region 321 having a first reflective property for the light and a second region 322 having a second reflective property different from the first reflective property for the light, the second region 322 being formed continuously with the first region 321 inside the first region 321, the insulator 42 of the insulated wire 4 having a third reflective property, for the light, different from the first reflective property and the second reflective property, and detecting that the first region 321 and the second region 322 are worn away and the insulator 42 of the insulated wire 4 is exposed, based on a measurement result of the reflected light.

The above description of the embodiment of the invention does not limit the invention to the scope of the claims. It should also be noted that not all of the combinations of features described in the embodiment are essential to the means for solving the problems of the invention. In addition, the invention can be transformed as appropriate to the extent that it does not depart from the intent of the invention, for example, it can be transformed and implemented as follows.

In the above embodiment, the case in which the third reflective property of the insulator 42 of the insulated wire 4 is different from the first reflective property of the first region 321 and the second reflective property of the second region 322 of the sheath 32 is described. The present invention is not limited thereto. The third reflective property may be the same as the first reflective property. Even in this case, it is possible to detect the degree of wear based on the intensity of the reflected light, since the intensity of the reflected light received by the light receiving unit 282 changes as the degree of wear progresses.

In the above embodiment, the case in which the first region 321 has higher light absorption and lower light reflectance than the second region 322 is described, but conversely, the first region 321 may have lower light absorption and higher light reflectance than the second region 322. It is also possible that the wear detection device 28 does not need to detect that the insulator 42 of the insulated wire 4 is exposed.

In the above embodiment, the case in which the cable 3 is used to supply electric power by electromagnetic induction to the transport cart 2 of the mobile system 1 is described, but the use of the cable of the present invention is not limited to this, and the cable of the present invention can be used for various applications such as various types of industrial machinery.

In the above embodiment, the case in which the conductor section 31 of the cable 3 is composed of six insulated wires 4 and the center filler 30 is described, but the configuration of the conductor section 31 is not limited to this and can be changed according to the required specifications. For example, when the conductor section 31 is composed of signal lines that transmit high-frequency signals, the first region 321 and the second region 322 may be composed of resin materials with different relative dielectric constants in order to adjust transmission characteristics. In this case, if the light reflectance in the first region 321 and the light reflectance in the second region 322 differ due to the difference in relative dielectric constant, the first reflective property of the first region 321 and the second reflective property of the second region 322 may be made different due to this difference in light reflectance.

In the above embodiment, the case in which the wear detection device 28 is installed in the transport cart 2 is described, but the installation location of the wear detection device 28 is not limited to this, and it can be installed at any location in the cable guide 14 or any other location where the wear of the sheath 34 can be detected.

1. A wear detectable cable, comprising:
a conductor section comprising a linear conductor; and
a sheath covering the conductor section,
wherein wear of the sheath can be detected by reflection of light irradiated toward the sheath,
wherein the sheath comprises a first region having a first reflective property for the light and a second region having a second reflective property different from the first reflective property for the light, and
wherein the second region is formed continuously with the first region inside the first region.

2. The wear detectable cable, according to claim 1, wherein a thickness of the second region is thinner than a thickness of the first region.

3. The wear detectable cable, according to claim 1, wherein the first region and the second region comprise a same type of resin material.

4. The wear detectable cable, according to claim 1, wherein the conductor section comprises an insulated wire including the conductor covered by an insulator, wherein the insulator of the insulated wire comprises a third reflective property, for the light, different from the first reflective property.

5. The wear detectable cable, according to claim 4, wherein the third reflective property is different from the second reflective property.

6. The wear detectable cable, according to claim 4, wherein a thickness of the insulator is thicker than the thickness of the second region.

7. The wear detectable cable, according to claim 1, wherein a hardness of the second region is higher than that of the first region.

8. The wear detectable cable, according to claim 1, wherein the second region is dispersed with light-reflective particles.

9. A wear detection device for detecting wear of the sheath of the wear detectable cable, according to claim 1, comprising:
an irradiation unit for irradiating the light toward the sheath;
a light receiving unit for receiving reflected light of the light; and
a detection processing unit that detects that the first region is worn away and the second region is exposed, based on a measurement result of an intensity of the reflected light received by the light receiving unit.

10. A wear detection method for detecting wear of a sheath in a cable comprising a conductor section including a linear conductor, and the sheath covering the conductor section, the method comprising:
measuring reflected light of light irradiated toward the sheath, the sheath comprising a first region having a first reflective property for the light and a second region having a second reflective property different from the first reflective property for the light, the second region being formed continuously with the first region inside the first region; and
detecting that the first region is worn away and the second region is exposed, based on a measurement result of the reflected light.

11. A wear detection method for detecting wear of a sheath in a cable comprising a conductor section including an insulated wire comprising a linear conductor covered with an insulator, and the sheath covering the conductor section, the method comprising:
measuring reflected light of light irradiated toward the sheath, the sheath comprising a first region having a first reflective property for the light and a second region having a second reflective property different from the first reflective property for the light, the second region being formed continuously with the first region inside the first region, the insulator of the insulated wire having a third reflective property, for the light, different from the first reflective property and the second reflective property; and
detecting that the first region and the second region are worn away and the insulator of the insulated wire is exposed, based on a measurement result of the reflected light.
